(19) United States
(12) Patent Application Publication
(10) Pub. No.: US 2006/0072340 A1
(43) Pub. Date: Apr. 6, 2006

(54) BACKLIGHT MODULE AND LCD APPARATUS

(76) Inventors: Cheng-Min Liao, Taoyuan County (TW); Wen-Yu Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,621

(22) Filed: Sep. 29, 2004

(51) Int. Cl. F21V 7/04

(52) U.S. Cl. 362/613

(57) ABSTRACT

A backlight module and a liquid crystal display (LCD) apparatus using the same are disclosed. The backlight module includes a bottom plate and multiple lamps disposed separately over the bottom plate. The bottom plate has multiple lower-reflectivity areas underneath the lamps and multiple higher-reflectivity areas between neighboring lower-reflectivity areas. The LCD apparatus includes such a backlight module and a LCD panel disposed over the lamps.

### BACKGROUND OF THE INVENTION

1. Field of the Invention

The present invention relates to a structure of a flat-panel display. More particularly, the present invention relates to a backlight module and a liquid crystal display (LCD) apparatus using the same.

2. Description of the Related Art

The backlight modules for providing backlight to LCD monitors or LCD-TV can be roughly classified into direct-type modules or side-edge modules. A side-edge module includes one or two side lamps as well as a light guide plate (LGP) for evenly spreading the light from the lamp onto the LCD panel disposed in front of the LGP.

FIG. 1 is a top view of a LCD apparatus having a conventional direct-type backlight module. As shown in FIG. 1, the direct-type backlight module includes several lamps 110 disposed underneath the LCD panel 120 of the LCD apparatus 100. Because multiple lamps are used instead of a light guide plate (LGP), the brightness uniformity of the LCD panel can be improved more easily. Hence, the direct-type backlight module is particularly suitable for a large-sized LCD apparatus.

However, the direct-type backlight module still has two major disadvantages, namely, lower brightness uniformity and larger thickness. As shown in FIG. 1, each area 120a of the LCD panel 120 directly above a lamp 110 is closest to the lamp 110, so that the direct light in the area 120a is stronger and the brightness there is higher. However, each area 120b of the LCD panel 120 is located further away from the lamp 110 and the brightness there is lower. Even when a diffusion plate is inserted between the lamps 110 and the LCD panel 120, alternating bright and dark bands can still be seen on the LCD panel 120 adversely affecting the display quality of the LCD panel 120. To reduce the brightness variation across the LCD panel 120, the distance between the LCD panel 120 and the lamps 110 is often increased so that the ratio of the distance between the LCD panel 120 and the lamps 110 to the distance between two lamps 110 is greater than 0.7. Unfortunately, this method will increase the overall thickness of the LCD apparatus.

### SUMMARY OF THE INVENTION

Accordingly, one object of this invention is to provide a direct-type backlight module that makes the LCD panel better in brightness uniformity, or allows the distance between the lamps and the LCD panel to be reduced.

This invention also provides a LCD apparatus that uses the direct-type backlight module of this invention to be better in brightness uniformity of LCD panel, or to be smaller in thickness due to reduction of the distance between the lamps and LCD panel.

To achieve these and other advantages and in accordance with the purposes of this invention, as embodied and broadly described herein, the invention provides a backlight module. The backlight module includes a bottom plate and multiple lamps disposed separately over the bottom plate. The bottom plate has multiple first areas with lower reflectivity underneath the lamps and multiple second areas with higher reflectivity, wherein each second area is between two first areas with lower reflectivity.

On the other hand, the LCD apparatus of this invention includes the above backlight module and a LCD panel disposed over the lamps.

In the backlight module and the LCD apparatus of the present invention, the bottom plate has lower reflectivity in each area underneath a lamp, so that the light reflected from such an area onto the area of the LCD panel directly above the lamp is weaker. Since the weaker reflective light on the panel area directly above the lamp can compensate for the stronger direct light on the same panel area, the brightness uniformity of the LCD panel is better and the display quality of the LCD panel is improved.

In other words, since an intensity variation of reflective light across the LCD panel is caused by the bottom plate to compensate for the intensity variation of direct light, a larger intensity variation of direct light across the LCD panel is tolerable as compared with the prior art. That is, the distance between the lamps and the LCD panel can be further reduced without sacrificing the brightness uniformity and display quality. Consequently, the thickness of the LCD apparatus can be further reduced.

It is to be understood that both the foregoing general description and the following detailed description are exemplary, and are intended to provide further explanation of the invention as claimed.

### BRIEF DESCRIPTION OF THE DRAWINGS

FIG. 1 is a top view of a LCD apparatus having a conventional direct-type backlight module.

FIG. 2 is a schematic cross-sectional view showing a LCD apparatus according to a first embodiment of the present invention.

FIG. 3 is a schematic cross-sectional view showing a LCD apparatus according to a second embodiment of the present invention.

FIG. 4 is a schematic cross-sectional view showing a LCD apparatus according to a third embodiment of the present invention.

FIG. 5 is a locally magnified view of the LCD apparatus shown in FIG. 2.

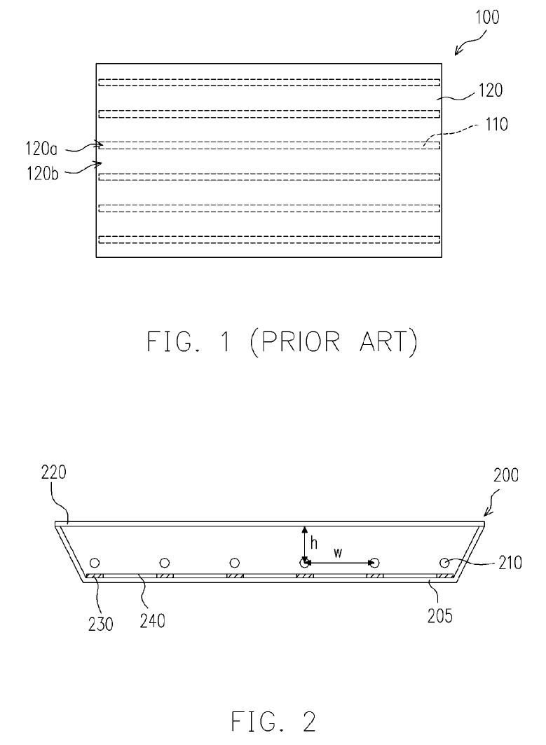

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIGS. 2/3/4 is a cross-sectional view showing the LCD apparatus according to the first/second/third embodiment of the present invention. As shown in each of FIGS. 2-4, the LCD apparatus 200 includes a bottom plate 205, a plurality of lamps 210 and a LCD panel 220. The bottom plate 205 and the lamps 210 together form a backlight module. The lamps 210 are preferably disposed in parallel and equidistantly over the bottom plate 205 to increase the brightness uniformity. In these embodiments, the areas with lower/higher reflectivity are formed using films having lower/higher reflectivity.

To increase the brightness uniformity of the LCD panel 220 and also utilize the light from the lamps 210 as completely as possible, the reflectivity of the areas with lower reflectivity is preferably 75-85%, and the reflectivity of the areas with higher reflectivity is preferably 90-99.9%. However, the more preferable combination is that the reflectivity of the areas with lower reflectivity is about 80% and the reflectivity of the areas with higher reflectivity is about 96%.

In the first embodiment as shown in FIG. 2, multiple lower- reflectivity films 230 and higher-reflectivity films 240 are alternately disposed on the bottom plate 205. The lower-reflectivity films 230 are positioned underneath the lamps 210 and each higher-reflectivity film 240 is disposed between two lower-reflectivity films 230. The lower-reflectivity films 230 and the higher-reflectivity films 240 form the aforementioned lower-reflectivity areas and higher-reflectivity areas, respectively, of the bottom plate 205. To fabricate such a bottom plate 250, for example, multiple lower-reflectivity films 230 and higher-reflectivity films 240 each having a predetermined size are cut off from a large-sized lower-reflectivity film and a large-sized higher-reflectivity film, respectively. Thereafter, the lower-reflectivity films 230 and the higher-reflectivity films 240 are attached to the predetermined areas of the bottom plate 205. The higher-reflectivity film can be made from 3M's ESR high-molecular polymer material, which can make a reflectivity up to 98%. The lower-reflectivity film can be a surface-treated metallic film, such as, an anodized aluminum film.

In the second embodiment as shown in FIG. 3, a single sheet of lower-reflectivity film 330 is disposed on the bottom plate 205, and multiple higher-reflectivity films 240 are disposed on the lower-reflectivity film 330. The higher-reflectivity films 240 are disposed on the lower-reflectivity film 330 away from the areas underneath the lamps 210 to form the aforementioned higher-reflectivity areas on the bottom plate 205. The lower-reflectivity areas are constituted of the exposed portions of the lower- reflectivity film 330 not covered by the high reflectivity films 240. To fabricate such a bottom plate 250, the single sheet of lower-reflectivity film 330 is attached to the bottom plate 250, and then the higher-reflectivity films 240 are attached to the predetermined areas of the lower-reflectivity film 330.

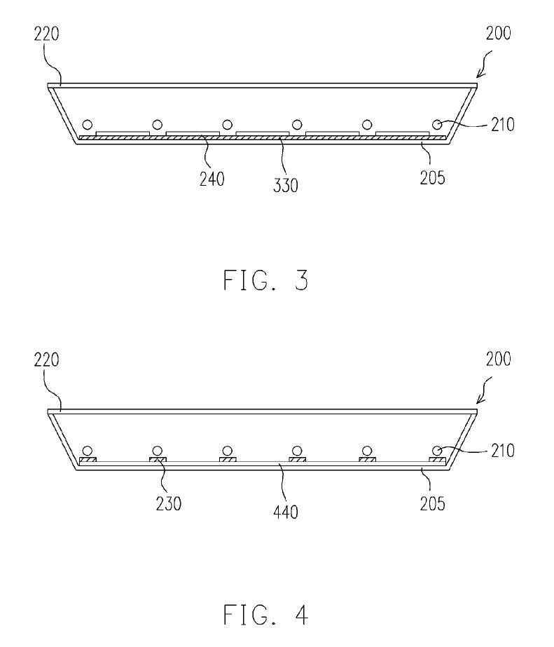

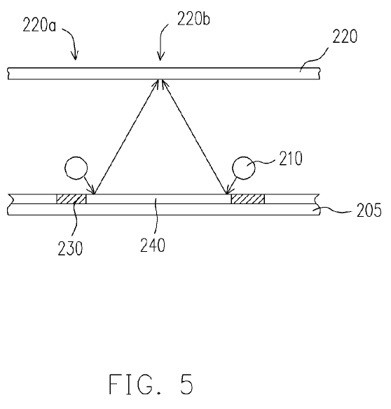

In the third embodiment as shown in FIG. 4, a single sheet of higher-reflectivity film 440 is disposed on the bottom plate 205, and multiple lower-reflectivity films 230 are disposed on the higher-reflectivity film 440. The lower-reflectivity films 230 are disposed on the areas of the higher-reflectivity film 440 underneath the lamps 210 to form the aforementioned lower-reflectivity areas of the bottom plate 205. The higher-reflectivity areas are constituted of the exposed portions of the higher-reflectivity film 440 not covered by the lower-reflectivity films 230. To fabricate such a bottom plate 250, the higher-reflectivity film 440 is attached to the bottom plate 250, and then the lower-reflectivity films 230 are attached to the predetermined areas of the higher-reflectivity film 440.

FIG. 5 is a locally magnified view of the LCD apparatus shown in FIG. 2. In the LCD apparatus, the reflectivity of the lower-reflectivity films 230 underneath the lamps 210 is lower, so that the reflective light from such areas to the areas 220a of the LCD panel 220 directly above the lamps 210 is weaker. The weaker reflective light on the areas 220a can compensate for the stronger direct light on the same areas 220a. On the contrary, the reflectivity of the higher-reflectivity films 240 not underneath the lamps 210 is higher, so that the reflective light from such areas to the areas 220b of the LCD panel 220 farther away from the lamps 210 is stronger. The stronger reflective light on the areas 220b can compensate for the weaker direct light on the same areas 220b. Hence, the present invention is able to enhance the brightness uniformity of a LCD panel and improve the display quality of the same.

In other words, since an intensity variation of reflective light across the LCD panel is caused by the bottom plate to compensate for the intensity variation of direct light, a larger intensity variation of direct light across the LCD panel is tolerable as compared with the prior art. Therefore, the ratio (h/w) of the lamp-to-panel distance “h” to the lamp-to-lamp distance “w” (see FIG. 2) can be reduced to below 0.7 without sacrificing the brightness uniformity and the display quality of the LCD panel, and the thickness of the LCD apparatus can be further reduced accordingly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a bottom plate; and
a plurality of lamps disposed separately over the bottom plate,
wherein the bottom plate has a plurality of first areas with lower reflectivity underneath the lamps and a plurality of second areas with higher reflectivity,
wherein each second area with higher reflectivity is between two first areas with lower reflectivity.

2. The backlight module of claim 1, wherein the lamps are arranged in parallel and equidistantly over the bottom plate.

3. The backlight module of claim 1, wherein the first areas comprise a plurality of lower-reflectivity films disposed on the bottom plate, and the second areas comprise a plurality of higher-reflectivity films disposed on the bottom plate.

4. The backlight module of claim 1, wherein
the bottom plate is disposed with a first film with lower reflectivity and a plurality of second films with higher reflectivity;
the second films are disposed on the first film to form the second areas with higher reflectivity; and
a plurality of areas of the first film not covered by the second films form the first areas with lower reflectivity.

5. The backlight module of claim 1, wherein
the bottom plate is disposed with a plurality of first films with lower reflectivity and a second film with higher reflectivity;
the first films are disposed on the second film to form the first areas with lower reflectivity; and
a plurality of areas of the second film not covered by the first films form the second areas with higher reflectivity.

6. The backlight module of claim 1, wherein the first areas has a reflectivity of about 75-85%, and the second areas has a reflectivity of about 90-99.9%.

7. The backlight module of claim 6, wherein the first areas has a reflectivity of about 80%, and the second areas has a reflectivity of about 96%.

8. A liquid crystal display apparatus, comprising:
a backlight module, comprising:
a bottom plate; and
a plurality of lamps disposed separately over the bottom plate,
wherein the bottom plate has a plurality of first areas with lower reflectivity underneath the lamps and a plurality of second areas with higher reflectivity,
wherein each second area is between two first areas; and a liquid crystal display panel disposed over the lamps.

9. The liquid crystal display apparatus of claim 8, wherein the lamps are arranged in parallel and equidistantly over the bottom plate.

10. The liquid crystal display apparatus of claim 9, wherein the ratio (h/w) of a distance “h” between the liquid crystal display panel and the lamps to the distance “w” between two lamps is below 0.7.

11. The liquid crystal display apparatus of claim 8, wherein the first areas comprise a plurality of lower-reflectivity films disposed on the bottom plate, and the second areas comprise a plurality of higher-reflectivity films disposed on the bottom plate.

12. The liquid crystal display apparatus of claim 8, wherein
the bottom plate is disposed with a first film with lower reflectivity and a plurality of second films with higher reflectivity;
the second films are disposed on the first film to form the second areas with higher reflectivity; and
a plurality of areas of the first film not covered by the second films form the first areas with lower reflectivity.

13. The liquid crystal display apparatus of claim 8, wherein
the bottom plate is disposed with a plurality of first films with lower reflectivity and a second film with higher reflectivity;
the first films are disposed on the second film to form the first areas with lower reflectivity; and
a plurality of areas of the second film not covered by the first films form the second areas with higher reflectivity.

14. The liquid crystal display apparatus of claim 8, wherein the first areas has a reflectivity of about 75-85%, and the second areas has a reflectivity of about 90-99.9%.

15. The liquid crystal display apparatus of claim 14, wherein the first areas has a reflectivity of about 80%, and the second areas has a reflectivity of about 96%.
